(19) United States
(12) Patent Application Publication
(10) Pub. No.: US 2008/0027806 A1
(43) Pub. Date: Jan. 31, 2008

(54) HOME EQUITY ESTIMATOR, BANNER PROVIDING INTERACTIVE HOME EQUITY ESTIMATION, AND METHOD FOR IMPLEMENTING THE SAME

(75) Inventors: Lawrence P. Martine, Los Angeles, CA (US); Christopher Catlow, Westlake Village, CA (US); David Collins, Westlake Village, CA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Countrywide Financial Corporation

(21) Appl. No.: 11/739,556

(22) Filed: Apr. 24, 2007

Related U.S. Application Data
(60) Provisional application No. 60/794,535, filed on Apr. 25, 2006.

(51) Int. Cl. G06Q 30/00; G06Q 40/00

(52) U.S. Cl. 705/14; 705/35

(57) ABSTRACT

An online banner advertisement is provided that enables a consumer to estimate the consumer's home value based on the state where the home is located, the year the home was purchased, and the purchase price. State-level data from Office of Federal Housing Enterprise Oversight (OFHEO) can be used to calculate the percentage increase in home value against the purchase price to estimate the current value of the home. An equity calculation can include deducting from the computed current value of the home the purchase price of the home. The calculation can include computing yearly cumulative appreciation value for each year, starting from the year the home was purchase to the present, based on the quarterly appreciation data. Consumers accessing the home equity estimation on the banner are given an option to contact a lender or to proceed to the lender's website where additional information, such as more specific home equity estimation, may be obtained. Consumer access to the banner and/or the home estimation tool available thereon can be monitored. Number of times that consumers access the more specific home equity information pages of the lender website, as well as the number of loan applications being generated as a result of such access can be tracked. Cost and benefits of providing the specific home equity information can be evaluated.

### CROSS-REFERENCE TO RELATED APPLICATIONS

The present application claims priority under 35 U.S.C. § 119 (e) to U.S. provisional patent application Ser. No. 60/794,535 filed Apr. 25, 2006, the entire content of which is expressly incorporated herein by reference.

### BACKGROUND OF THE INVENTION

1. Field of the Invention

The present invention finds application in the lending industry, and generally in the field of interactive web-based advertising. In particular, the present invention provides a web-based home equity estimator, banner providing interactive home equity estimation and method for implementing the same.

2. Description of the Related Art

In the lending industry, where lenders include, for example, home mortgage providers, there are a number of conventional websites that offer home valuation data. Some of these sites offer property-specific data and require entry of property-specific information. Other cites provide a banner page which requests, for example, a zip code or a state, and then proceeds to a website which requests further property-specific information before performing home evaluation calculations. However, nationwide coverage is not currently available through any single source. Examples of such conventional websites, some of which are illustrated in FIGS. 1-4, include:

www.zillow.com which provides home-specific information for approximately 65 million homes in its data base. Most of the information is two to three years out of date.

www.neighborhoodscout.com which provides neighborhood-specific information and requires a subscription to its service.

www.homestore.com (see FIG. 4) which provides metro area-specific information using Office of Federal Housing Enterprise Oversight (OFHEO) data; however, the information provided by this website is usually out of date.

www.realtytrac.com which provides ZIP code-specific information based on data obtained from local realtor contacts.

www.homegain.com (see FIG. 2) which provides home-specific information based on publicly available data on the specific property.

www.quickenloans.com (see FIG. 1) which provides home-specific information based on publicly available data on specific property, in particular, census records and real estate records.

www.ditech.com (see FIG. 3) which provides home-specific information based on specific property information available from First American Bank.

Conventional advertisements (including banners) typically assume that a consumer knows how much equity they have in their home or use an average home value to offer their lowest payment. For example, some of the advertisings use positioning such as: “$180,000 mortgage for $xxx/Month”.

None of these websites, nor any of the lenders on the market today, offer a home value estimator within their banner advertising. Instead, in some case, as listed above, certain lenders offer a tool which can estimates property-specific home values within their website or on their landing pages.

### SUMMARY OF THE INVENTION

The present invention provides a method and an apparatus to address at least the drawbacks noted above.

According to an exemplary embodiment of the present invention, an online banner advertisement is provided that enables a consumer to estimate the consumer's home value based on the state where the home is located, the year the home was purchased, and the purchase price. According to an exemplary implementation, state-level data from OFHEO is used to calculate the percentage increase in home value against the purchase price to estimate the current value of the home. In an exemplary implementation, an “equity” calculation includes deducting from the computed current value of the home the purchase price of the home.

According to an exemplary embodiment of the present invention, the banner advertisement comprises an internet pop-up on a web-based display.

According to another exemplary embodiment of the present invention, a home equity estimator is provided which estimates equity in a home based on quarterly appreciation data by state published and updated by OFHEO. In an exemplary implementation, the calculation comprises computing yearly cumulative appreciation value for each year, starting from the year the home was purchase to the present, based on the quarterly appreciation data.

According to yet another exemplary embodiment of the present invention, a method is provided for implementing web-based home equity estimator and the banner providing interactive home equity estimation where consumers accessing the home equity estimation on the banner are given an option to contact a lender or to proceed to the lender's website where additional information, such as more specific home equity estimation, may be obtained.

According to an exemplary implementation of the present invention, the method further provides for monitoring of consumer access to the banner and/or the home estimation tool available thereon.

According to yet another exemplary implementation of the present invention, the method comprises keeping track of the number of times that consumers access the more specific home equity information pages of the lender website, as well as the number of loan applications being generated as a result of such access.

According to yet another exemplary implementation of the present invention, the method comprises evaluating the cost and benefits of providing the specific home equity information, which information may not be available free of charge to the lender, based on economic success of the banner advertising in terms of, for example, number of new loan applications generated by consumer access thereof.

### BRIEF DESCRIPTION OF THE DRAWINGS

The above and other objects, features and advantages of the present invention will become more apparent from the following detailed description when taken in conjunction with the accompanying drawings in which:

FIGS. 1-4: illustrate typical websites which provide conventional home value estimation.

FIG. 5: is a flowchart illustrating home equity estimation according to an exemplary embodiment of the present invention.

FIGS. 6-11: illustrate a banner providing interactive home equity estimation according to an exemplary embodiment of the present invention.

FIG. 12: is a flowchart illustrating an example of providing additional information for home equity estimation according to an exemplary embodiment of the present invention.

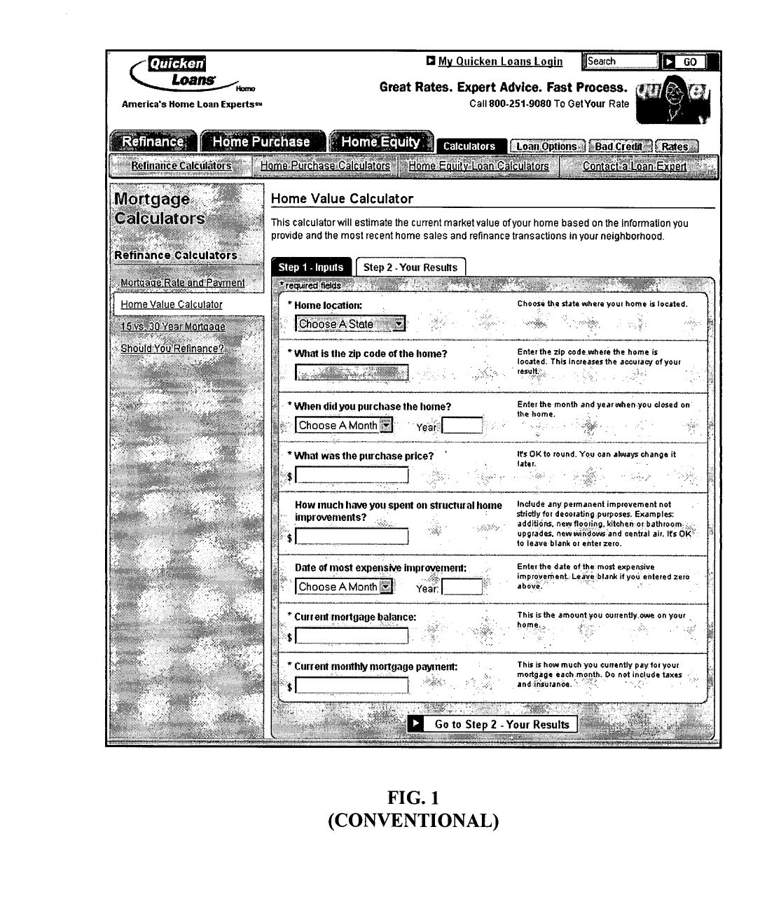

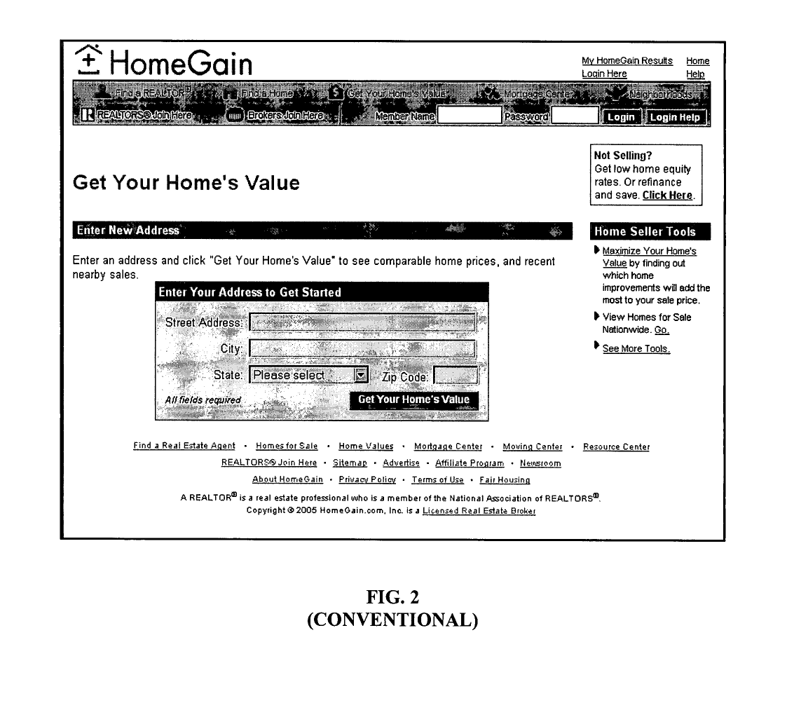

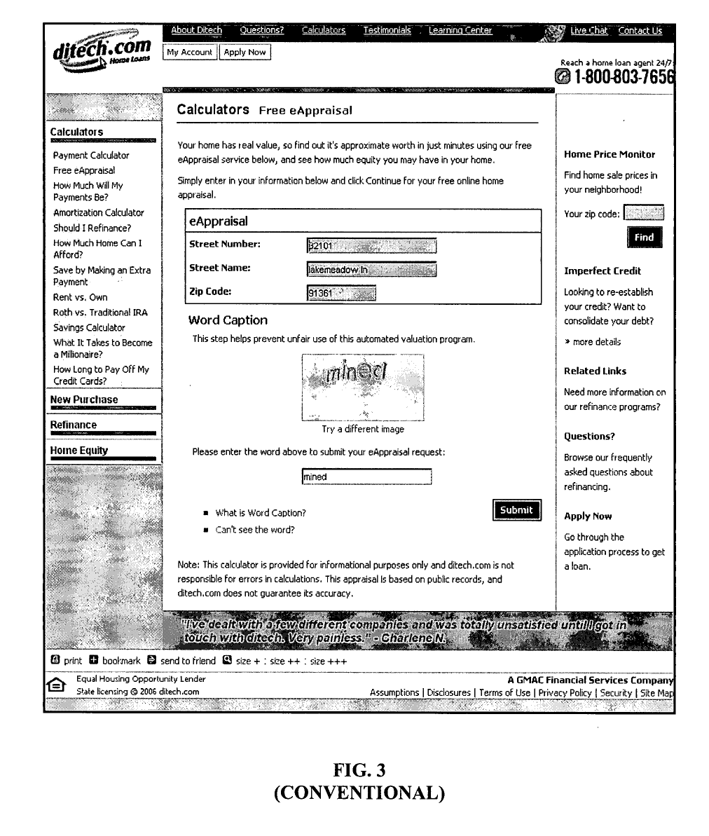

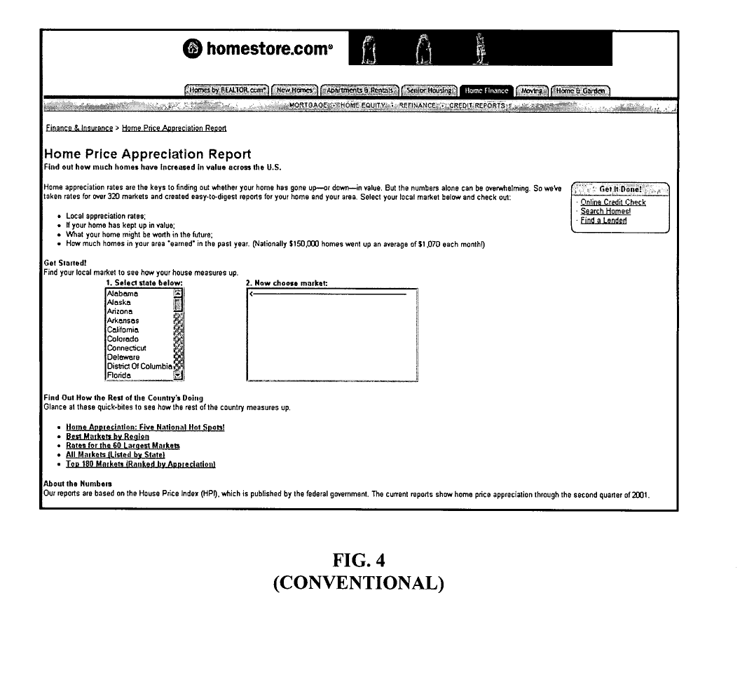

### DETAILED DESCRIPTION OF EXEMPLARY EMBODIMENTS

The matters defined in the description such as a detailed construction, method steps and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions, method steps and constructions are omitted for clarity and conciseness.

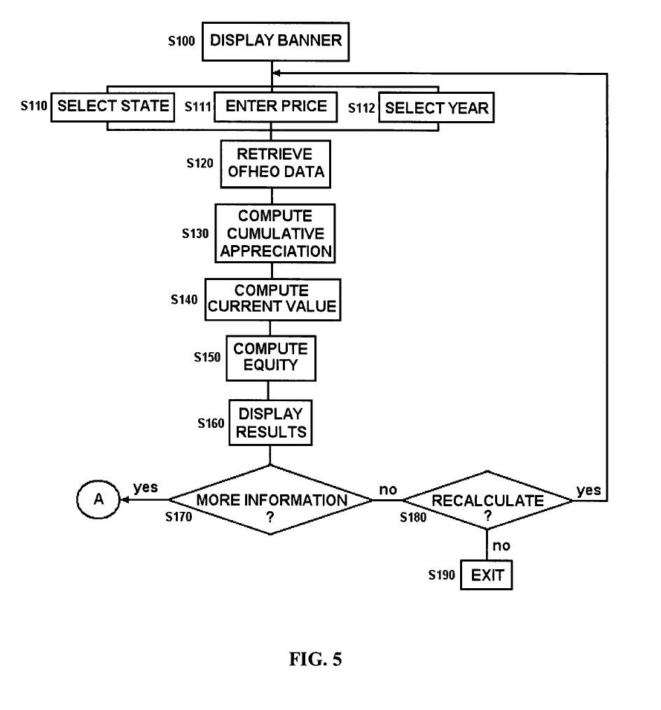

Referring to FIG. 5, according to an exemplary embodiment of the present invention a banner providing interactive home equity estimation is displayed (in step S1100) on the screen, for example as a pop-up, while accessing the Internet.

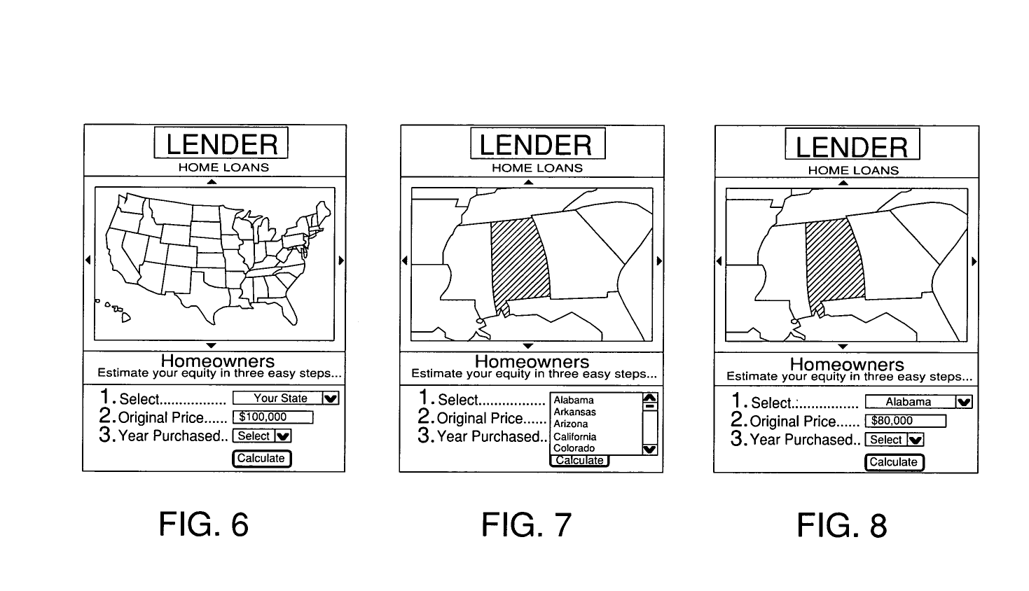

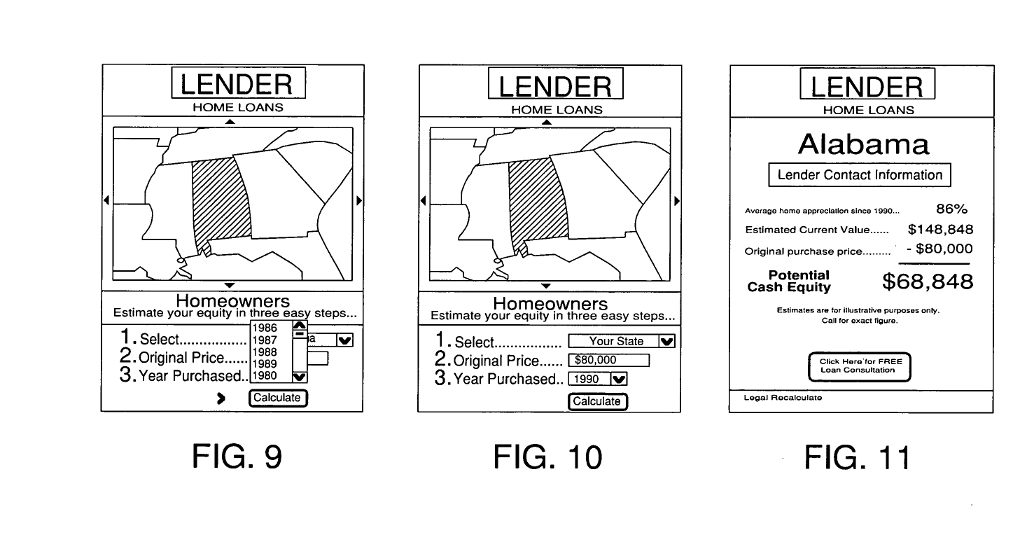

In an exemplary implementation, the banner, as shown in FIG. 6, comprises three interactive areas which ask the consumer to select the state where the home is located (step S110), to enter the purchase price of the home (step S111), and to select the year that the home was purchased (step S112). In an exemplary implementation, the state and the purchase year are selectable by means of a pull-down menu (see FIGS. 7 and 9, respectively). As will be appreciated by skilled artisans other methods of data entry may also be implemented, such direct entry via a keyboard (see FIG. 8) as in the case of the purchase price. In this regard, in an exemplary implementation, the state may be selected by choosing an appropriate geographic location on the map (see FIG. 7).

After the consumer enters the state, purchase price and year information, OFHEO data for the appropriate years, based on the consumer-entered year information, is accessed (step S120). In an exemplary implementation, the OFHEO data can be stored in a database which is kept current as new OFHEO data is made available.

Using the OFHEO House Price Index (HPI) which contains 25 years of data on annual house price increases by state nationwide, home value appreciation is computed (step S130) and current home value is estimated (step S140) within the online advertising banner (at the property state level).

According to an exemplary implementation, the home value appreciation and current home value are estimated based on the OFHEO data as follows.

OFHEO publishes quarterly appreciation data by state, and updates this data regularly. Using the base data, a cumulative appreciation is calculated for each year based on the quarterly appreciation figures, and then annually for the number of years owned. Table I shows as an example of the calculations for a purchase price of $80,000.00 and the state of Arizona.

TABLE 1
Purchase Price $ 80,000.00
State Arizona
Year Purchased 1998
Current Value $ 150,729.41
Equity $ 70,729.41

| From | To | Rate Increased | Amount |
|---|---|---|---|
| 1998 | 1999 | 4.88% | $ 83,900.00 |
| 1999 | 2000 | 5.87% | $ 88,822.83 |
| 2000 | 2001 | 6.78% | $ 94,847.24 |
| 2001 | 2002 | 5.47% | $ 100,035.39 |
| 2002 | 2003 | 5.79% | $ 105,827.43 |
| 2003 | 2004 | 12.47% | $ 119,018.82 |
| 2004 | 2005 | 26.64% | $ 150,729.41 |

The cumulative data for the sate of Arizona is shown on Table 2 below.

TABLE 2

| | | |
|---|---|---|
| 1998 | 7 | 88.41% |
| 1999 | 6 | 79.65% |
| 2000 | 5 | 69.70% |
| 2001 | 4 | 58.92% |
| 2002 | 3 | 50.68% |
| 2003 | 2 | 42.43% |
| 2004 | 1 | 26.64% |

Based on the computed cumulative data the original purchase price of the home is multiplied by the corresponding appreciation rate to come out with the same figure. Using the same example: $80,000×(1+88.41%)=$150,728

After all of the information has been entered, as shown in FIG. 10, potential equity is computed by subtracting the purchase price from the computed current value (step S150). The results of the calculations are displayed in the banner advertisement (step S160) as shown in FIG. 11. While the results are displayed, the consumer is asked whether more detailed information is desired (step S170).

If the response at step S170 is NO, the consumer is asked whether the results should be recalculated (step S180). If the response at step S180 is NO, the banner is exited. On the other hand, if the response at step S180 is YES, the consumer banner returns to awaiting input of the home state, purchase price and year of purchase as shown in FIG. 6.

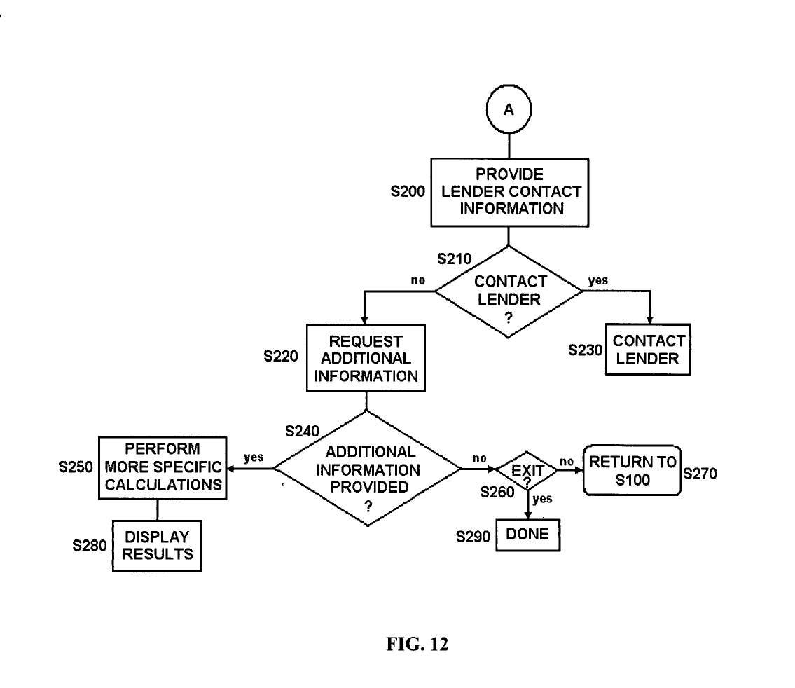

If the response at step S170 is YES, then, as shown in FIG. 12, the consumer is provided with lender contact information (step S200) and given an option to contact the lender (step S210). If the consumer chooses to contact the lender, the consumer may do so by, for example, calling the lender directly or by sending an email to the lender (step S230). If the consumer does not wish to contact the lender, the consumer is presented with a web-based tool which allows the consumer to request additional home-specific information (step S220). The additional home-specific information is provided if the consumer, in turn, provides additional information (step S240), such as home address, necessary to generate the home-specific information. The level of detail requested from the consumer and provided by the web-based tool can be tailored based on cost-benefit analysis as discussed subsequently.

If the consumer provides the additional information, then the more home-specific calculations are performed (step S250) and the results are displayed (step S280) in the web-based tool environment.

If the consumer does not wish to provide the additional information, then the consumer is given an option to exit (step S260) and conclude the process (step S290). If the consumer chooses not to exit, the consumer is returned to the display banner (step S270), as shown in FIG. 6 (in an exemplary implementation, the user can be returned to the banner displaying the last performed calculation, as shown in FIG. 11).

As described above, an exemplary objective of the present invention comprises a concept of a banner advertisement which enables a consumer to select his or her state, the year that the home was bought, and enter the home's purchased price. Using the HPI data for the selected year and state, and applying that percentage increase to the purchase price the home value is display and estimated within the banner advertisement. The consumer is also provided with an estimated home equity. (See FIG. 11.) Thus, the consumer may be encouraged to call the lender, or obtain more specific information on line, to find out how much equity the consumer can leverage. This may lead to increased number of loan applications, and consequently issued loans which would directly benefit the lender.

According to an exemplary implementation, by using the concept of “calculate your equity” a lender offers interactivity. When a consumer is offered a research aid and interacts with the aid, a consumer is more likely to be invested in the process, and in turn will be more likely to contact the lender and apply for a loan.

According to an exemplary embodiment of the present invention, the success of the interactive research aid offered by certain implementations of the present invention can be measured in terms of, for example, the number of times that a consumer accesses the lender's website to obtain the more specific information (for example, by counting the number of “hits” at step S230 of FIG. 12). The success can also be measured based on the number of times that the consumer contacts the lender (step 240 of FIG. 12) as a result of interaction with the banner advertisement.

According to another exemplary embodiment of the present invention, based on the measured success, cost-benefit analyses can be performed with regard to the amount of specific data that needs to be provided to the consumer (which has a cost correlated to the level of detail provided) to obtain optimum number of, for example, loans issued as a result of the interaction with the banner advertisement.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

Although several exemplary embodiments of the present invention have been disclosed for illustrative purposes, those skilled in the art will appreciate that various modifications, additions and substitutions are possible, without departing from the scope of the invention. Accordingly, the present invention is not limited to the above-described embodiments.

What is claimed:

1. A method comprising:
displaying a banner advertisement during an internet access session, the banner advertisement enabling interactive input for at least one of state data, price data and purchase date data;
detecting whether at least one of the state data and the purchase date data in the banner advertisement have been input;
computing at least one of estimated current value and potential equity value based on at least one of the state data, the price data and the purchase date data; and
displaying within the banner advertisement home equity information comprising at least one of the estimated current value and the potential equity value.

2. The method of claim 1, wherein the computing comprises using state-level data from the Office of Federal Housing Enterprise Oversight (OFHEO) to calculate a percentage increase in home value based on the purchase data to compute the estimated current value.

3. The method of claim 1, wherein the purchase data comprises a purchase price, and the computing comprises deducting from the estimated current value the purchase price to compute the estimated current value.

4. The method of claim 1, wherein the displaying of the banner advertisement comprises displaying an internet pop-up on a web-based display.

5. The method of claim 1, wherein the purchase date data comprises the year of purchase, the method further comprising:
receiving a current date;
accessing quarterly appreciation data by state from state-level data from the Office of Federal Housing Enterprise Oversight (OFHEO); and
computing a yearly cumulative appreciation value for each year, starting from the year of the purchase to the current date, based on the quarterly appreciation data.

6. The method of claim 1, wherein the interactive input of the banner advertisement further comprises interactive input for at least one of an option to contact a lender and an option to proceed to a lender website, the method further comprising:
entering the lender website when detecting the option to proceed to the lender website to display additional options or information; and
displaying contact information of the lender when detecting the option to contact the lender.

7. The method of claim 6, wherein the lender website provides the additional information comprising at least one of lender-specific information, home equity information and an option to request a more detailed calculations to obtain a more property-specific equity estimation.

8. The method of claim 1, further comprising monitoring consumer access to at least one of the banner and a home estimation tool available thereon.

9. The method of claim 6, further comprising monitoring consumer access to at least one of the lender website and the contact information.

10. The method of claim 6, further comprising monitoring consumer access to at least one of the lender-specific information, the home equity information and the option to request the more detailed calculations.

11. The method of claim 6, further comprising monitoring a number of loan applications generated by the lender as a result of access to the lender website.

12. The method according to claim 1, further comprises evaluating at least one of cost and benefit to a lender providing the home equity information.

13. The method of claim 12, wherein the cost comprises cost of obtaining, maintaining or providing the home equity information.

14. The method of claim 12, wherein the benefit comprises an economic success of the banner advertising based on a number of new loan applications generated by consumer access thereof.

15. A banner advertisement displayable during an internet access session, the banner advertisement comprising:
interactive input for state data;
interactive input for price data;
interactive input for purchase date data, wherein detecting input of at least one of the state data and the purchase date data is detected, and at least one of estimated current value and potential equity value is computed based on at least one of the state data, the price data and the purchase date data; and
a display area for displaying home equity information comprising at least one of the estimated current value and the potential equity value.

16. The banner of claim 15, comprising an internet pop-up on a web-based display, the internet pup-up comprising the interactive input for state data, the interactive input for price data, the interactive input for purchase date data and the display area.

17. A computer readable medium having stored thereon computer-executable instructions comprising:
a first set of instructions for displaying a banner advertisement during an internet access session, the banner advertisement comprising interactive input for at least one of state data, price data and purchase date data;
a second set of instructions for detecting whether at least one of the state data and the purchase date data in the banner advertisement have been input;
a third set of instructions for computing at least one of estimated current value and potential equity value based on at least one of the state data, the price data and the purchase date data; and
a fourth set of instructions for displaying within the banner advertisement home equity information comprising at least one of the estimated current value and the potential equity value.

18. The computer readable medium of claim 17, wherein the first set of instructions comprises displaying an internet pop-up on a web-based display.

19. The computer readable medium of claim 17, wherein the purchase date data comprises the year of purchase, the instructions further comprising:
a fifth set of instructions for receiving a current date;
a sixth set of instructions for accessing quarterly appreciation data by state from state-level data from the Office of Federal Housing Enterprise Oversight (OFHEO); and
a seventh set of instructions for computing a yearly cumulative appreciation value for each year, starting from the year of the purchase to the current date, based on the quarterly appreciation data.

20. The computer readable medium of claim 17, further comprising an eighth set of instructions for monitoring consumer access to at least one of the banner and a home estimation tool available thereon.

21. The computer readable medium of claim 17, further comprising a ninth set of instructions for evaluating at least one of cost and benefit to a lender of providing the home equity information.
